(19) United States
(12) Patent Application Publication
(10) Pub. No.: US 2026/0350435 A1
(43) Pub. Date: Nov. 5, 2026

(54) INFORMATION PROCESSING APPARATUS, METHOD, AND NON-TRANSITORY COMPUTER READABLE MEDIUM

(71) Applicant: KABUSHIKI KAISHA TOSHIBA, Kawasaki-shi Kanagawa (JP)

(72) Inventor: Yuichi KATO, Moriya Ibaraki (JP)

(73) Assignee: KABUSHIKI KAISHA TOSHIBA, Kawasaki-shi Kanagawa (JP)

(21) Appl. No.: 19/454,575

(22) Filed: Jan. 21, 2026

(30) Foreign Application Priority Data
Jan. 27, 2025 (JP) 2025-011432

(51) Int. Cl. G06N 5/04

(52) U.S. Cl. CPC G06N 5/04

(57) ABSTRACT

According to one embodiment, an information processing apparatus includes processing circuitry. The processing circuitry determine a mask position of an attentional matrix for a machine learning model having an attention mechanism. The processing circuitry trains the machine learning model to execute a task corresponding to the mask position, using training data and the attentional matrix having the determined mask position.

### CROSS-REFERENCE TO RELATED APPLICATION

This application is based upon and claims the benefit of priority from Japanese Patent Application No. 2025-011432, filed Jan. 27, 2025, the entire contents of which are incorporated herein by reference.

### FIELD

Embodiments described herein relate generally to an information processing apparatus, a method, and a non-transitory computer readable medium.

### BACKGROUND

In training of a language generation model that is a causal language model (CLM) such as GPT, autoregressive tasks are used. With a trained model that has been trained on autoregressive tasks, it is possible to predict a next token, but it is difficult to infer a fill-in-the-blank task that requires prediction of the content of a masked part of a sentence. Meanwhile, in training of a language generation model that is a masked language model (MLM) such as BERT, the model is trained to predict a masked word from the preceding and following tokens and the context. Therefore, it is possible to execute a fill-in-the-blank task, but it is difficult to execute a generation task.

### BRIEF DESCRIPTION OF DRAWINGS

FIG. 1 is a block diagram showing an example configuration of an information processing apparatus according to the present embodiment.

FIG. 2 is a flowchart showing an example operation to be performed by the information processing apparatus according to the present embodiment.

FIG. 3 is a diagram illustrating an example of a mask position of an attentional matrix according to the present embodiment.

FIG. 4 is a diagram illustrating a specific example of training of a machine learning model according to the present embodiment.

FIG. 5 is a block diagram showing an example of the hardware configuration of the information processing apparatus according to the present embodiment.

### DETAILED DESCRIPTION

In general, according to one embodiment, an information processing apparatus includes processing circuitry. The processing circuitry determine a mask position of an attentional matrix for a machine learning model having an attention mechanism. The processing circuitry trains the machine learning model to execute a task corresponding to the mask position, using training data and the attentional matrix having the determined mask position.

In the description below, an information processing apparatus, a method, and a program according to the present embodiment will be described in detail with reference to the drawings. Note that, in the following embodiment, portions denoted by the same reference numerals perform the same operations, and explanation of them will not be repeatedly made.

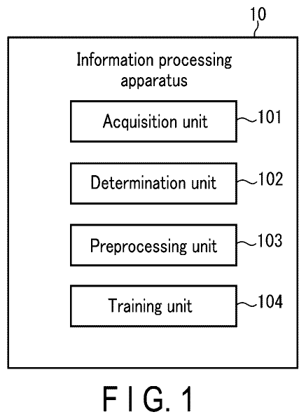

The configuration of an information processing apparatus according to the present embodiment will be described with reference to a block diagram shown in FIG. 1.

An information processing apparatus 10 includes an acquisition unit 101, a determination unit 102, a preprocessing unit 103, and a training unit 104.

The acquisition unit 101 acquires training data. The training data may be data of any types, regardless of multidimensional data and time series data, such as image data, moving image data, natural language data, symbol data, sensor data, control signal data, audio data, music data, log data, transaction data, and table data.

The determination unit 102 determines a mask position of an attentional matrix for a machine learning model having an attention mechanism. An example of the machine learning model having an attention mechanism may be a machine learning model including a transformer, but any machine learning model including an attention mechanism can also be adopted. The attentional matrix is a matrix indicating a result of calculation of an inner product calculated with respect to all combinations of tokens that are input to the machine learning model.

The preprocessing unit 103 performs preprocessing such as tokenization processing and embedding processing on the training data, to generate vector representation. Also, the preprocessing unit 103 replaces some tokens of the training data with a special token.

The training unit 105 trains the machine learning model to execute a task corresponding to the mask position, using the training data and the attentional matrix having the mask position determined.

Note that, although not illustrated in the drawing, the information processing apparatus 10 may include a storage unit that stores training data, a machine learning model, a trained model that is a machine learning model for which training has been completed, various kinds of information about a training process for machine learning models, and the like.

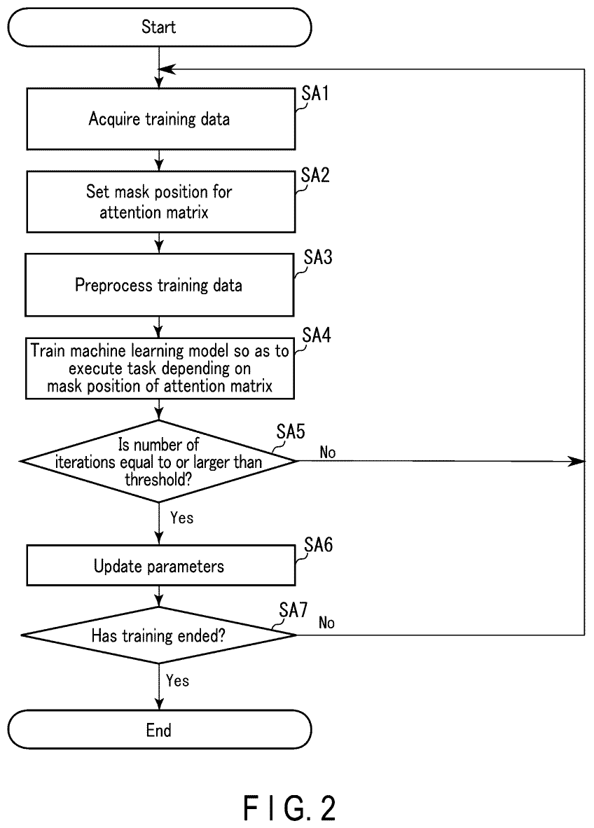

Next, an example operation to be performed by the information processing apparatus 10 according to the present embodiment is described with reference to a flowchart in FIG. 2.

In step SA1, the acquisition unit 101 acquires training data. The training data may be acquired from an external device, or, in a case where the information processing apparatus 10 includes a storage unit and the training data is stored in the storage unit, the training data may be acquired from the storage unit.

In step SA2, the determination unit 102 determines a mask position of an attentional matrix. The mask position is determined by two training schemes in this embodiment. One is a training scheme that is based on the assumption of a masked language model (MLM), and performs so-called bidirectional training to predict a masked token by referring to the entire input tokens. The other is a training scheme that is based on the assumption of a causal language model (CLM), and performs so-called causal relationship training to predict a prediction target token by referring to only the (past) tokens before the prediction target token.

The determination unit 102 may determine the mask position, based on the iterations in the training of the machine learning model. For example, for each iteration, the mask position may be determined depending on whether the number of iterations is an even number or is an odd number. Specifically, in a case where the number of iterations is an even number, for example, an attentional matrix mask position on the assumption of bidirectionality may be determined, and, in a case where the number of iterations is an odd number, an attentional matrix mask position on the assumption of the direction of causal relationship may be determined. Alternatively, the opposite combination may be used. In a case where the number of iterations is an odd number, an attentional matrix mask position on the assumption of bidirectionality may be determined, and, in a case where the number of iterations is an even number, an attentional matrix mask position on the assumption of the direction of causal relationship may be determined.

In step SA3, the preprocessing unit 103 performs preprocessing on the training data. For example, if the training data has not been tokenized, the training data is tokenized, and is expressed in vector representation by embedding processing. Also, the preprocessing unit 103 adds special tokens to the tokens in the training data in one batch process. The special token adding process is a process of adding <BOS> to the top of a token and adding <EOS> to the end of the token. Further, the preprocessing unit 103 performs preprocessing on the training data, based on the mask position of the attentional matrix. For example, in a case where the mask position of the attentional matrix relates to the bidirectional training scheme, some tokens are replaced with a special token <MASK>.

In step SA4, the training unit 104 trains the machine learning model to execute a task corresponding to the mask position of the attentional matrix, using the training data. Specifically, the training unit 104 switches loss calculation methods, depending on the mask position based on the attentional matrix. That is, in a case where an attentional matrix having a mask position compatible with bidirectionality is used, training is performed so as to execute a prediction task to predict a masked token. In a case where an attentional matrix having a mask position compatible with the direction of causal relationship is used, training is performed so as to execute a prediction task to predict the next token from the past tokens. The training unit 104 calculates a loss value with a loss function corresponding to the mask position of the attentional matrix, and calculates a gradient regarding each parameter of the machine learning model using the loss value, based on an error back-propagation method.

In the case of an attentional matrix having a mask position on the assumption of the direction of causal relationship, the loss value L_{CLM} can be expressed by Expression (1).

$${L}_{CLM} = - \frac{1}{L} {\sum }_{l = 1}^{L} log {p}_{θ , CLM} ( {x}_{l} \vert {x}_{< l} ) \qquad ( 1 )$$

Here, θ represents a parameter of the machine learning model, and p_{θ,CLM}(xₗ|x_{<l}) represents a probability distribution in which xₗ is output when a token sequence x_{<l} including tokens smaller than the l-th one is input.

On the other hand, in the case of an attentional matrix having a mask position on the assumption of bidirectionality, the loss value L_{MLM} can be expressed by Expression (2).

$${L}_{MLM} = - \frac{1}{{L}_{m}} {\sum }_{i = 1}^{L} {m}_{l} log {p}_{θ , MLM} ( {x}_{l} \vert \hat{x} ) \qquad ( 2 )$$

Here, p_{θ,MLM}(xₗ|x\hat{ }) represents a probability distribution in which xₗ is output when a token sequence x\hat{ } is input. Note that “\hat{ }” represents a superscript hat. Here, mi takes “1” in the case of a masked word (token), and takes “0” in the case of some other token. Lₘ represents the number of masked tokens.

In step SA5, the training unit 104 determines whether the number of iterations is equal to or greater than a threshold. If the number of iterations is equal to or greater than the threshold, the process proceeds to step SA6. If the number of iterations is smaller than the threshold, the process returns to step SA1, and the same processing is repeated.

In step SA6, the training unit 104 updates the parameters of the machine learning model, based on the gradient. Specifically, it is assumed that a weighted average of gradients based on the loss value of each loss function calculated in step SA4 is used as the gradient herein.

In step SA7, the training unit 104 determines whether the training has finished. For example, the training unit 104 may determine that the training has finished if the number of epochs in the training is equal to or larger than a threshold, or may determine that the training has finished if each loss value corresponding to the mask position is equal to or smaller than a threshold. Upon completion of the training, a trained model is generated. In a case where the training has not finished, the process returns to step SA1, and the similar processing is repeated.

Note that the determination unit 102 may determine the mask position, depending on the number of steps related to updating of parameters of the machine learning model. For example, in a case where the number of steps reaches a predetermined number, the mask position on the assumption of bidirectionality and the mask position on the assumption of the direction of causal relationship may be switched.

Also, the determination unit 102 may determine the mask position, depending on the loss values shown in Expressions (1) and (2). For example, if the loss value with respect to the mask position on the assumption of bidirectionality is equal to or greater than the threshold, it is considered that the training has not progressed for a prediction task regarding bidirectionality. Therefore, it is only required that a mask position on the assumption of bidirectionality is determined so that the loss value becomes smaller than the threshold, and the training is continued. In this manner, by taking into consideration the loss values in the training regarding bidirectionality and the direction of causal relationship, it is possible to increase the inference accuracy of tasks regarding both bidirectionality and the direction of causal relationship.

Note that the training unit 104 may update the parameters by changing the weight of the weighted average of the gradient. The weight of the weighted average may be changed with the number of parameter steps. Also, the weight of the weighted average may be changed with the loss value of the machine learning model depending on the mask position. Also, the weight of the weighted average may be changed with the magnitude of change in the loss value between steps, with respect to the loss value of the machine learning model depending on the mask position. Alternatively, the weight of the weighted average may be changed with a combination of these. For example, in a case where it is desired to increase the prediction accuracy in terms of either bidirectionality or the direction of causal relationship during the training of the machine learning model, the weight of the gradient to be calculated from the loss value with respect to the direction in which the prediction accuracy is to be increased should be increased.

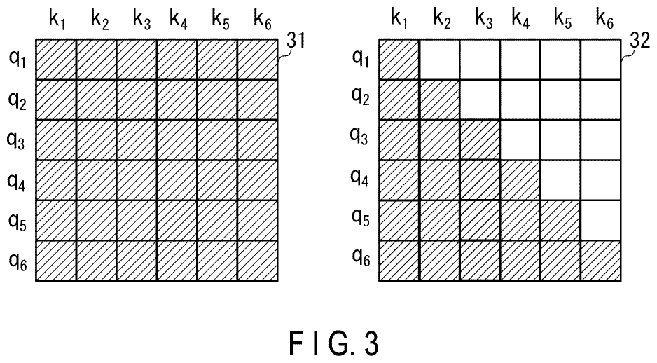

Next, an example of a mask position of an attentional matrix according to the present embodiment is described with reference to FIG. 3.

The left diagram in FIG. 3 is an attentional matrix 31 in a training scheme according to MLM, or in a case where the prediction direction is bidirectional. The right diagram in FIG. 3 is an attentional matrix 32 in a training scheme according to CLM, or in a case where the prediction direction is the direction of causal relationship.

Here, qᵢ (i being a natural number) represents a query of each token, and kⱼ (j being a natural number) represents a key of each token. As the token sequence length is six in the example in FIG. 3, i=1 to 6, and j=1 to 6. The shaded region indicates that attention is applied, and the blank indicates that attention is not applied.

That is, in the attentional matrix 31 compatible with bidirectionality, the entire attentional matrix 31 is shaded, which means that a value serving as an attentional weight is set in the entire attentional matrix 31. That is, a masked token is predicted from the entire input query including the masked token. On the other hand, in the attentional matrix 32 compatible with the direction of causal relationship, a value is set in (q₁, k₁) for the first token, values are set in (q₁, k₁), (q₂, k₁), and (q₂, k₂) for the second token, and no values are set in (q₂, k₃) to (q₂, k₆). That is, the prediction target token is predicted, only with the use of the (past) token sequence before the prediction target token.

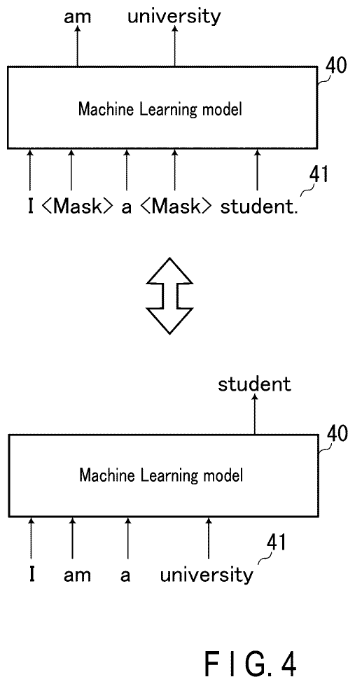

Next, a specific example of training of a machine learning model according to the present embodiment is described with reference to FIG. 4.

FIG. 4 illustrates an example in which text data, “I am a university student”, is used as training data 41 for a machine learning model 40. The upper diagram in FIG. 4 illustrates a case where a machine learning model is trained with an attentional matrix compatible with bidirectionality. Here, the words “am” and “university” are converted into tokens “<Mask>”, and the text data “I am a university student” is input as tokens to the machine learning model 40. The machine learning model 40 is trained to be able to predict the words “am” and “university” by referring to information about all the tokens that have been input.

The lower diagram in FIG. 4 illustrates a case where a machine learning model is trained with an attentional matrix compatible with the direction of causal relationship. Here, the text data “I am a university student” is input as tokens to the machine learning model 40. The machine learning model 40 is trained to be able to predict the information, “I am a university” and “student”, regarding the tokens before the prediction target token.

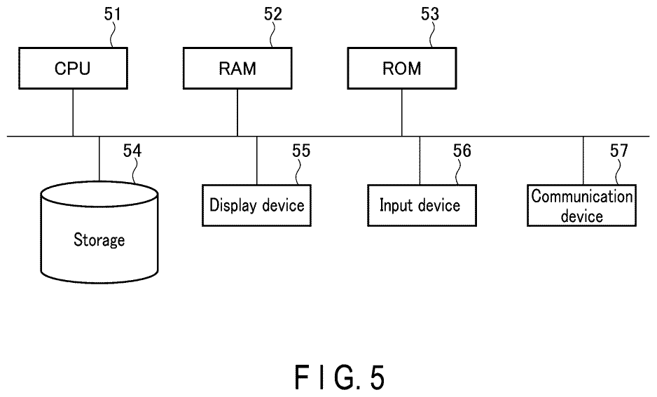

Next, an example of the hardware configuration of the information processing apparatus according to the present embodiment is shown in a block diagram in FIG. 5.

The information processing apparatus 10 includes a central processing unit (CPU) 51, a random access memory (RAM) 52, a read only memory (ROM) 53, a storage 54, a display device 55, an input device 56, and a communication device 57, which are connected by a bus.

The CPU 51 is a processor that performs an arithmetic process, a control process, and the like in accordance with programs. The CPU 51 uses a predetermined region in the RAM 52 as a work area, and performs processes as the processes to be performed by the respective components of the information processing apparatus 10 described above, in cooperation with programs stored in the ROM 53, the storage 54, and the like. Note that the respective processes to be performed by the information processing apparatus 10 may be performed by one processor, or may be performed in a distributed manner by a plurality of processors.

The RAM 52 is a memory such as a synchronous dynamic random access memory (SDRAM). The RAM 52 functions as a work area for the CPU 51. The ROM 53 is a memory that stores programs and various kinds of information in a non-rewritable manner.

The storage 54 is a device that writes and reads data into and from a magnetic recording medium such as a hard disc drive (HDD), a semiconductor storage medium such as a flash memory, a magnetically recordable storage medium such as an HDD, an optically recordable storage medium, or the like. The storage 54 writes and reads data into and from a storage medium, under the control of the CPU 51.

The display device 55 is a display device such as a liquid crystal display (LCD). The display device 55 displays various kinds of information, based on a display signal from the CPU 51.

The input device 56 includes input devices such as a mouse and a keyboard. The input device 56 receives information that has been input by an operation from the user as an instruction signal, and outputs the instruction signal to the CPU 51.

The communication device 57 communicates with an external device via a network, under the control of the CPU 51.

According to the present embodiment described above, an information processing apparatus determines a mask position of an attentional matrix for a machine learning model having an attention mechanism, and trains the machine learning model to execute a task corresponding to the mask position, using training data and the attentional matrix having the mask position determined.

As a result, it is possible to perform training while switching between an attentional matrix compatible with bidirectionality and an attentional matrix compatible with the direction of causal relationship in each iteration, and it is possible to train the machine learning model while reflecting both trainings when updating a parameter. Thus, it is possible to perform training on both MLM and CLM tasks, such as a token generation task, a fill-in-the-blank task, and a fill-in-the-blank generation task. Accordingly the number of tasks that can be performed with one model can be increased.

The instructions shown in the processing procedures described in the above embodiment can be executed based on a program that is software. By storing this program in advance and reading this program, a general-purpose computer system can achieve effects similar to the effects of a control operation on the above-described information processing apparatus. The instructions described in the above embodiment are recorded as a program that can be executed by a computer, into a magnetic disk (a flexible disk, a hard disk, or the like), an optical disk (a CD-ROM, a CD-R, a CD-RW, a DVD-ROM, a DVD±R, a DVD±RW, a Blu-ray (registered trademark) Disc, or the like), a semiconductor memory, or a recording medium similar to them. The storage format may be in any form, as long as the recording medium can be read by a computer or a system into which a computer is incorporated. In a case where a computer reads a program from the recording medium and causes the CPU to execute, based on the program, the instructions written in the program, it is possible to realize an operation similar to the control on the information processing apparatus of the above-described embodiment. In a case where the computer acquires or reads the program, the program may of course be acquired or read through a network.

Further, an operating system (OS), database management software, middleware (MW) such as a network, or the like that is running in a computer based on instructions in a program installed from a recording medium into the computer or a system into which the computer is incorporated may execute part of each process for realizing the present embodiment.

Furthermore, a recording medium in the present embodiment is not limited to a medium independent of the computer or the system into which the computer is incorporated, and includes a recording medium that downloads and stores or temporarily stores a program transmitted via a LAN, the Internet, or the like.

Furthermore, the number of recording media is not necessarily one, and a case where processing according to the present embodiment is executed from a plurality of media is also included in the recording media in the present embodiment, and the configuration of the media may be any configuration.

Note that the computer or the system into which the computer is incorporated in the present embodiment is for executing each process in the present embodiment based on a program stored in a recording medium, and may have any configuration of a device formed with a single personal computer, a single microcomputer, or the like, a system in which a plurality of devices is connected to a network, or the like.

Further, the computer in the present embodiment is not necessarily a personal computer, but includes an arithmetic processing device, a microcomputer, or the like included in an information processing apparatus, and collectively refers to machines and devices capable of realizing the functions in the present embodiment in accordance with a program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising processing circuitry configured to:
determine a mask position of an attentional matrix for a machine learning model having an attention mechanism; and
train the machine learning model to execute a task corresponding to the mask position, using training data and the attentional matrix having the determined mask position.

2. The apparatus according to claim 1, wherein the processing circuitry is configured to switch loss calculation methods, depending on the mask position.

3. The apparatus according to claim 1, wherein, depending on the determined mask position, the processing circuitry is configured to determine whether the mask position is compatible with bidirectionality referring to entire tokens of the training data that has been input to the machine learning model, or the mask position is compatible with a direction of causal relationship referring to only a past token before a prediction target token.

4. The apparatus according to claim 3, wherein the processing circuitry is configured to train the machine learning model to execute the prediction task compatible with the bidirectionality or the prediction task compatible with the direction of causal relationship.

5. The apparatus according to claim 1, wherein the processing circuitry is further configured to replace a token of the training data with a special token, depending on the mask position.

6. The apparatus according to claim 1, wherein the processing circuitry is configured to determine the mask position, based on an iteration at training of the machine learning model.

7. The apparatus according to claim 1, wherein the processing circuitry is configured to determine the mask position, depending on a number of steps regarding parameter update in the machine learning model.

8. The apparatus according to claim 1, wherein the processing circuitry is configured to determine the mask position, depending on a loss value of the machine learning model for each mask position.

9. The apparatus according to claim 1, wherein the processing circuitry is configured to update a parameter of the machine learning model, using a weighted average of gradients calculated from a loss value of the machine learning model for each mask position.

10. The apparatus according to claim 9, wherein the processing circuitry is configured to update the parameter by changing a weight of the weighted average.

11. The apparatus according to claim 10, wherein the weight of the weighted average changes depending on at least one of a number of steps of the parameter, a loss value of the machine learning model for each mask position, or a magnitude of change in a loss value between steps with respect to the loss value of the machine learning model for each mask position.

12. An information processing method comprising:
determining a mask position of an attentional matrix for a machine learning model having an attention mechanism; and
training the machine learning model to execute a task corresponding to the mask position, using training data and the attentional matrix having the determined mask position.

13. A non-transitory computer readable medium including computer executable instructions, wherein the instructions, when executed by a processor, cause the processor to perform a method comprising:
determining a mask position of an attentional matrix for a machine learning model having an attention mechanism; and
training the machine learning model to execute a task corresponding to the mask position, using training data and the attentional matrix having the determined mask position.
